(19) United States
(12) Patent Application Publication
(10) Pub. No.: US 2014/0070800 A1
(43) Pub. Date: Mar. 13, 2014

(54) MAGNETIC FIELD GENERATION UNIT AND SEMICONDUCTOR TEST APPARATUS INCLUDING THE SAME

(71) Applicants: Ho-Youn CHO, Hwaseong-si (KR); Daeshik KIM, Hwaseong-si (KR); Dongseok CHO, Seongnam-si (KR)

(72) Inventors: Ho-Youn CHO, Hwaseong-si (KR); Daeshik KIM, Hwaseong-si (KR); Dongseok CHO, Seongnam-si (KR)

(21) Appl. No.: 14/022,156

(22) Filed: Sep. 9, 2013

(30) Foreign Application Priority Data
Sep. 12, 2012 (KR) 10-2012-0101050

(51) Int. Cl. G01N 27/72

(52) U.S. Cl. CPC G01N 27/72
USPC 324/228

(57) ABSTRACT

A test apparatus can be provided which includes a test control unit configured to input electrical signals for testing a semiconductor device including a magneto-resistive element, and to receive test result signals from the semiconductor device. A station unit can be configured to support the semiconductor device during testing. A magnetic field generation unit can be configured to apply a magnetic field to the semiconductor device during testing. And a magnetic control unit can be configured to control the magnetic field generation unit. Using the test apparatus, characteristics of the semiconductor device can be tested during application of a magnetic field.

### CROSS-REFERENCE TO RELATED APPLICATIONS

A claim for priority under 35 U.S.C. §119 is made to Korean Patent Application No. 10-2012-0101050 filed Sep. 12, 2012, in the Korean Intellectual Property Office, the entire contents of which are hereby incorporated by reference.

### BACKGROUND

The inventive concepts described herein relate to a test apparatus, and more particularly, to an apparatus for testing a semiconductor memory device including magneto-resistive element cells.

Even as the size of semiconductor products becomes smaller, there are greater demands for the processing of mass data within the semiconductor products. Hence, it is necessary to speed up the operation of memory elements used in the semiconductor products while increasing the degree of integration. This requirement may be satisfied, for instance, by using a magnetic RAM (MRAM) device. MRAM devices provide a memory function that operates by using a variation in resistance resulting from a polarity change of a magnetic material within the MRAM device.

A semiconductor product including an MRAM device may be fabricated through a method including a fabrication (FAB) process in which a plurality of semiconductor devices is formed on a wafer, an electric die sorting (EDS) process in which electric properties of each semiconductor device formed on the wafer are tested, and an assembly process in which semiconductor devices determined as a good die at the ESD process are separated and then mounted on packages to be protected from external mechanical, physical and chemical impacts.

Among the processes, the EDS process may be a process for determining whether semiconductor devices formed on the wafer are defective. At the EDS process, defective semiconductor devices may be repaired and non-repairable semiconductor devices may be discarded. After the assembly process, package testing may be performed to determine whether semiconductor devices are defective.

Unfortunately, however, since a general test apparatus does not include a magnetic field generation unit, it is difficult to test the operating properties of the MRAM devices using magneto-resistive elements while under the influence of an external magnetic field.

### SUMMARY

One aspect of embodiments of the inventive concepts is directed to providing a test apparatus which comprises a test control unit configured to input and output electrical signals for testing a semiconductor device including a magneto-resistive element. A station unit is configured to fix or permit movement of the semiconductor device during testing. A magnetic field generation unit is configured to apply a magnetic field to the semiconductor device. And a magnetic control unit is configured to control the magnetic field generation unit, wherein an electric characteristic of the semiconductor device can be tested while a magnetic field is applied to the semiconductor device.

In example embodiments, the magnetic control unit can control both the direction and strength of the magnetic field applied to a semiconductor device arranged in the test apparatus.

In example embodiments, the test apparatus can further comprise an actuator configured to adjust a horizontal angle of the magnetic field generation unit with respect to the test apparatus to change a direction of a magnetic field applied to the semiconductor device.

In example embodiments, the station unit may be a wafer chuck when the semiconductor device is at a wafer level. In other embodiments, the station unit may be a socket, in which the semiconductor device is mounted, when the semiconductor device is at a package level.

In example embodiments, the magnetic field generation unit may be placed under the station unit to apply a vertical magnetic field to the semiconductor device.

In other example embodiments, the magnetic field generation unit may be placed on one side of the station unit to apply a horizontal magnetic field to the semiconductor device while the station unit rotates.

Another aspect of the inventive concepts is directed to providing a read operation testing method of a semiconductor device. The read operation testing method can comprise reading an initial data value from a semiconductor device including a magneto-resistive element using a read current; reading data from the semiconductor device while an external magnetic field is applied to the semiconductor device; and measuring a value of the external magnetic field applied at a point of time when the read data is different from the initial data value.

In example embodiments, a magnetic direction of the external magnetic field can be opposite to a magnetization direction of a free layer of the magneto-resistive element in the semiconductor device.

Still another aspect of the inventive concepts is directed to providing a write operation testing method of a semiconductor device. The write operation testing method can comprise writing data to a semiconductor device including a magneto-resistive element using a write current; determining whether data is written at the semiconductor device; when data is not written to the semiconductor device, writing data by applying an external magnetic field while at the same time over-applying a write current; and measuring a value of the external magnetic field applied at a point in time when the data is written.

In example embodiments, a magnetic direction of the external magnetic field is the same as a magnetization direction of a free layer of the magneto-resistive element to be written.

### BRIEF DESCRIPTION OF THE FIGURES

The above and other objects and features will become more readily apparent from the following description with reference to the following figures, wherein like reference numerals refer to like parts throughout the various figures unless otherwise specified, and wherein:

FIG. 1 is a block diagram schematically illustrating a test apparatus according to an embodiment of the inventive concepts.

FIG. 2 is a block diagram schematically illustrating a semiconductor device of FIG. 1 according to an embodiment of the inventive concepts.

FIG. 3 is a schematic exploded perspective view of an STT-MRAM cell that can be used to provide a nonvolatile memory cell in the semiconductor device of FIG. 2.

FIGS. 4A and 4B are schematic diagrams of a magneto-resistive element which illustrate a magnetization direction of a magneto-resistive element and a read operation.

FIG. 5 is a schematic diagram of a magneto-resistive element illustrating a write operation of an STT-MRAM cell.

FIG. 6 is a graph illustrating a variation of a write current according to a magnetic field.

FIG. 7 is a block diagram schematically illustrating a magnetic control unit and a magnetic field generation unit according to an embodiment of the inventive concepts.

FIG. 8 is block diagram schematically illustrating a test apparatus according to another aspect of the inventive concepts.

FIGS. 9 to 11 are block diagrams schematically illustrating a test apparatus according to still another embodiment of the inventive concepts and further illustrating positioning of the magnetic field generation unit during test operations of the test apparatus.

FIG. 12 is a block diagram schematically illustrating a test apparatus according to still another embodiment of the inventive concepts.

FIGS. 13 and 14 are block diagrams schematically illustrating a test apparatus and testing method according still other embodiments of the inventive concepts.

FIG. 15 is a block diagram schematically illustrating a test apparatus according to still another embodiment of the inventive concepts.

FIG. 16 is a flow chart schematically illustrating a read operation testing method according to an embodiment of the inventive concepts.

FIG. 17 is a flow chart schematically illustrating a write operation testing method according to an embodiment of the inventive concepts.

### DETAILED DESCRIPTION

Various different embodiments of the inventive concepts will now be described in detail with reference to the accompanying drawings. The inventive concepts, however, may be embodied in various different forms, and should not be construed as being limited only to the illustrated embodiments. Rather, these embodiments are provided as examples so that this disclosure will be thorough and complete, and will fully convey the inventive concepts to those skilled in the art. Accordingly, known processes, elements, and techniques may not be described with respect to some of the embodiments of the inventive concepts. Unless otherwise noted, like reference numerals denote like elements throughout the attached drawings and written description, and thus descriptions of those elements may not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concepts.

Spatially relative terms, such as “beneath”, “below”, “lower”, “under”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concepts. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

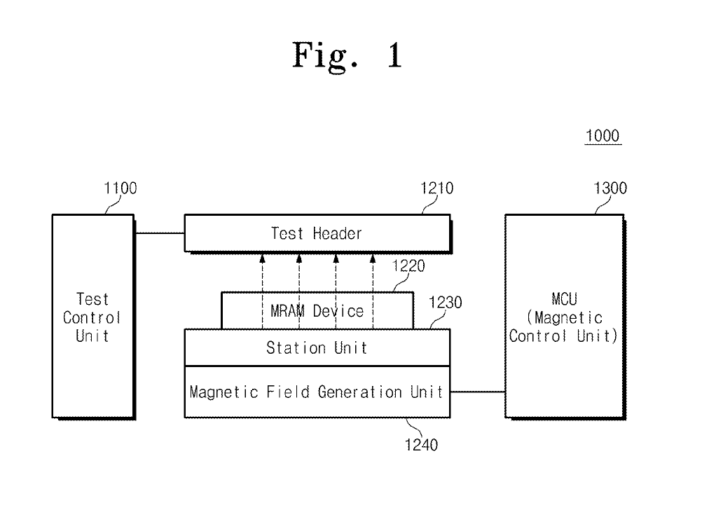

FIG. 1 is a block diagram schematically illustrating a test apparatus according to an embodiment of the inventive concepts. Referring to FIG. 1, a test apparatus 1000 may include a test control unit 1100, a test header 1210, a station unit 1230, a magnetic field generation unit 1240, and a magnetic control unit 1300.

The test apparatus 1000 may test a semiconductor device (e.g., MRAM) 1220 while a magnetic field is applied. Using the inventive concepts, it is possible to test the influence of a magnetic field on various operations of the semiconductor device 1220 before its implementation in a product.

Referring to FIG. 1, the test control unit 1100 may generate electrical signals for testing the semiconductor device 1220 and send the electrical signals to the test header 1210. The test control unit 1100 may then determine whether the semiconductor device 1220 operates normally, based on electrical signals corresponding to a test result, provided from the test header 1210.

More particularly, the test header 1210 may receive a signal from the test control unit 1100 and send it to the semiconductor device 1220. The test header 1210 may, for instance, be electrically connected with the semiconductor device 1220 via a probe card (not shown).

The semiconductor device 1220 under test may include MRAM cells, and may be at a wafer or package level. A structure of the test apparatus 1000 may vary according to a state of the semiconductor device 1220. For example, if the semiconductor device 1220 is at a wafer level, the station unit 1230 may be a wafer chuck. Alternatively, if the semiconductor device 1220 is at a package level, the station unit 1230 may be a socket.

The magnetic field generation unit 1240 may be placed under the station unit 1230, and may apply a vertical magnetic field to the semiconductor device 1220 during testing of the semiconductor device 1220. The magnetic field generation unit 1240 may, for example, be formed of a permanent magnet or an electromagnet. The magnetic field generation unit 1240 may be controlled by the magnetic control unit 1300.

The magnetic control unit 1300 may control activation and deactivation of the magnetic field generation unit 1240 during testing of the semiconductor device 1220. In addition, the magnetic control unit 1300 may adjust the strength a magnetic field generated from the magnetic field generation unit 1240 and the direction of the magnetic field applied to the semiconductor device 1220.

The test apparatus 1000 may predict properties of a semiconductor device (e.g., MRAM device 1220) which reacts sensitively to an external magnetic field. Thus, using the inventive concepts, it is possible to improve the data reliability of the semiconductor device.

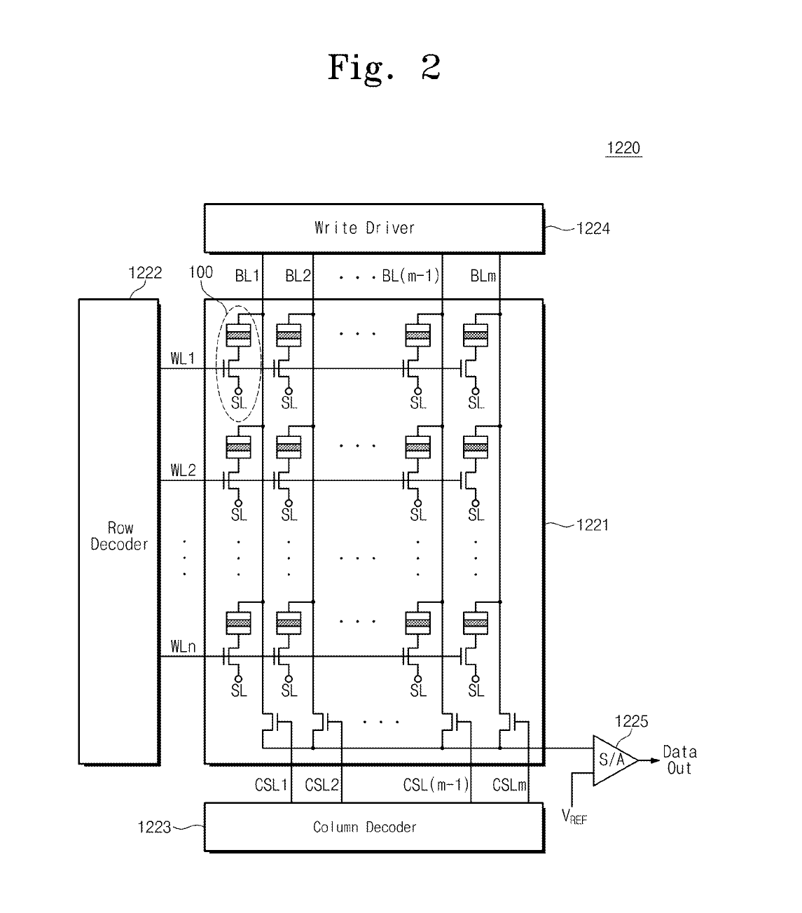

FIG. 2 is a block diagram schematically illustrating a semiconductor device of FIG. 1 according to an embodiment of the inventive concepts. Referring to FIG. 2, a semiconductor device 1220 may include a cell array 1221, a row decoder 1222, a column decoder 1223, a write driver 1224, and a sense amplifier 1225.

The cell array 1221 may include a plurality of word lines WL1 to WLn (wherein n is a natural number greater than 1), a plurality of bit lines BL1 to BLm (wherein m is a natural number greater than 1), and a plurality of memory cells 100 arranged at intersections of the word lines WL1 to WLn and the bit lines BL1 to BLm. Where the memory cells 100 are formed of STT-MRAM (spin transfer torque magnetic resistive random access memory) cells, each of the memory cells 100 may include a cell transistor and a magneto-resistive element having a magnetic material.

It should be noted, however, that the magneto-resistive elements can be replaced with resistive elements of a phase change random access memory (PRAM) which performs memory operations using a phase change material, a resistive random access memory (RRAM), which performs memory operations using a variable resistance material such as complex metal oxide, and so on. Resistance values of materials forming resistive elements may vary according to a level or direction of a current or voltage, and may be retained even when the current or voltage is interrupted.

The row decoder 1222 and the column decoder 1223 may each include a plurality of switches. The row decoder 1222 may select a word line in response to a row address, and the column decoder 1223 may generate column selection signals CSL1 to CSLm to select one bit line. The plurality of bit lines BL1 to BLm may be connected with the write driver 1224. The write driver 1224 may apply a write current to the memory cell 100 in response to an external command.

During a data read operation, a voltage of a bit line may vary according to a resistance value of the memory cell 100. A voltage applied to the bit line may be transferred to the sense amplifier 1225, and the sense amplifier 1225 may sense a difference between the bit line voltage and a reference voltage Vref to output a data signal.

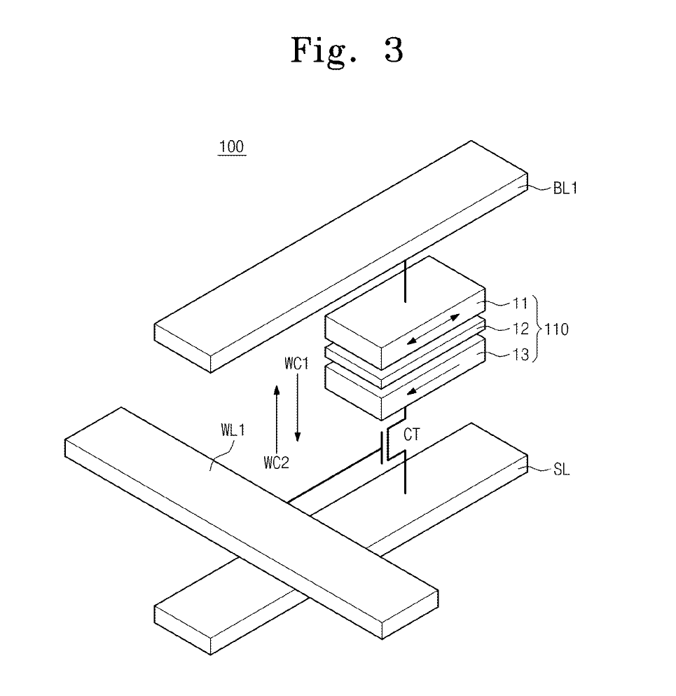

FIG. 3 is a schematic exploded perspective view of an STT-MRAM cell used as a nonvolatile memory cell in the semiconductor device of FIG. 2. Referring additionally to FIG. 3, a memory cell 100 may include a magneto-resistive element 110 and a cell transistor CT. A gate of the cell transistor CT may be connected to a word line WL1, one end thereof may be connected to a bit line BL1 via the magneto-resistive element 110, and the other end thereof may be connected to a source line SL.

The magneto-resistive element 110 may include a pinned layer 13, a free layer 11, and a tunnel layer 12 interposed between the pinned layer 13 and the free layer 11. A magnetization direction of the pinned layer 13 may be pinned. A magnetization direction of the free layer 11 may have the same direction as the pinned layer 13 or a direction opposite to the pinned layer 13, depending on a memory state of the magneto-resistive element 110. An anti-ferromagnetic layer (not shown) may further be provided to pin a magnetization direction of the pinned layer 13.

During a write operation of the STT-MRAM cell, a high-level voltage may be applied to the word line WL1 to turn on the cell transistor CT, and a write current WC1/WC2 may be provided between the bit line BL1 and the source line SL.

During a read operation of the STT-MRAM cell, a high-level voltage may be applied to the word line WL1 to turn on the cell transistor CT, and a read current may be provided in a direction from the bit line BL1 to the source line SL. Data stored in the magneto-resistive element 110 may be read by sensing a resistance value measured under the above bias condition.

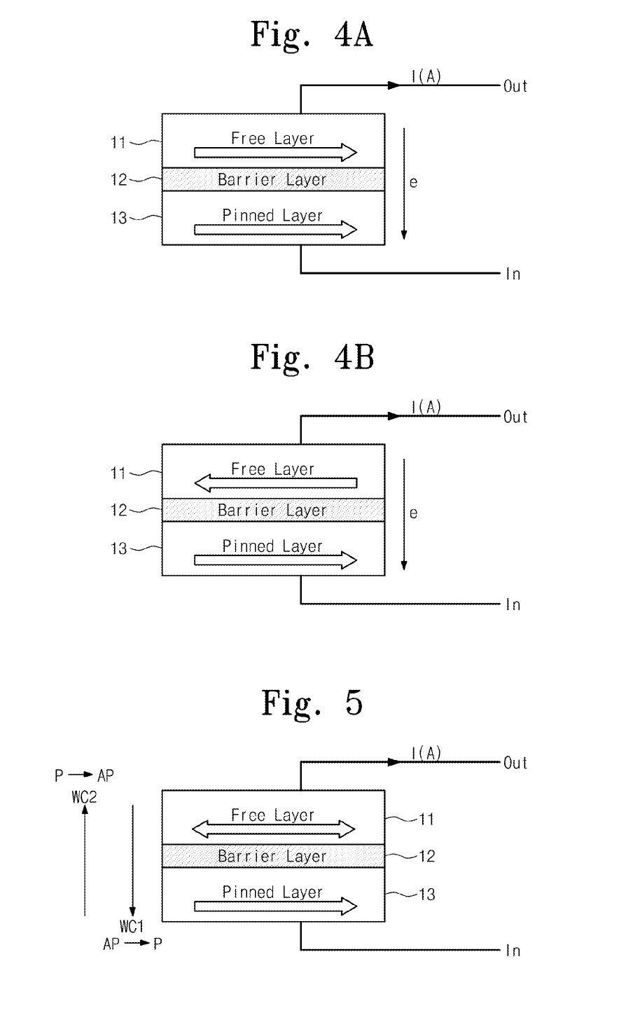

FIGS. 4A and 4B are diagrams illustrating a magnetization direction of a magneto-resistive element and further illustrating a read operation. Referring additionally to FIGS. 4A and 4B, a resistance value of a magneto-resistive element may vary according to a magnetization direction of a free layer 11. If a read current I(A) is applied to the magneto-resistive element 110, a data voltage may be output, with the data value depending on a resistance value of the magneto-resistive element 110. Since the intensity of the read current I(A) is less than the intensity of a write current, in general, a magnetization direction of the free layer 11 should not be changed by application of the read current I(A).

Referring specifically to FIG. 4A, in this example, the magnetization directions of the free and pinned layers 11 and 13 are parallel (e.g., in the same direction). In this case, the magneto-resistive element 110 will have a small resistance value during the read operation, and a data value of ‘0’ may be read.

Referring now to FIG. 4B, in this example, the magnetization directions of free and pinned layers 11 and 13 may be anti-parallel (or, opposite each other). Thus, during a read operation, the magneto-resistive element 110 may have a large resistance value. In this case, a data value of ‘1’ may be read.

In FIGS. 4A and 4B, the free and pinned layers 11 and 13 of the magneto-resistive element 110 are illustrated as being a horizontal magnetic element. However, the inventive concept is not limited thereto. For example, the free and pinned layers 11 and 13 of the magneto-resistive element could be implemented using a vertical magnetic element.

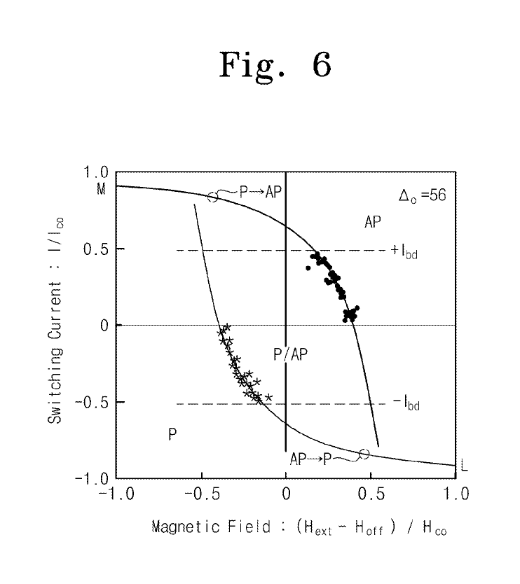

FIG. 5 is a schematic block diagram illustrating a write operation of an STT-MRAM cell. Referring to FIG. 5, a magnetization direction of a free layer 11 may be decided by a direction of a write current WC1/WC2 flowing through the magneto-resistive element 110. For example, if a first write current WC1 is applied, free electrons having the same spin direction as a pinned layer 13 may apply a torque to the free layer 11. In this case, the free layer 11 and the pinned layer 13 may be magnetized in parallel. However, if a second write current WC2 is applied, electrons having spins opposite to the pinned layer 13 may apply a torque to the free layer 11. In this case, the free layer 11 and the pinned layer 13 may be magnetized to be anti-parallel to each other. That is, a magnetization direction of the free layer 11 may be changed by a spin transfer torque (STT).

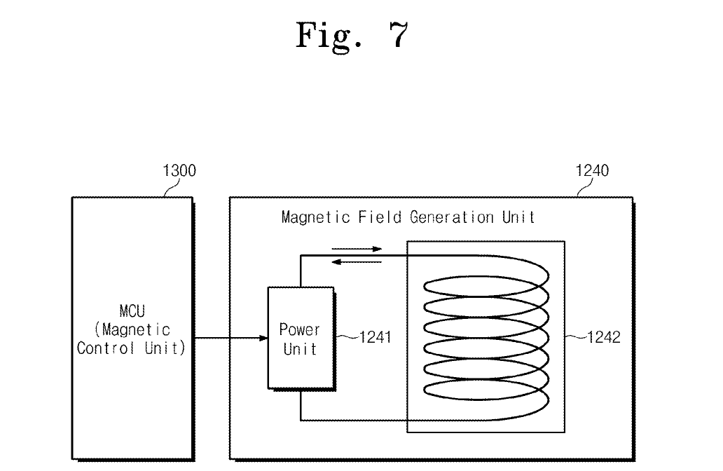

FIG. 6 is a graph illustrating a variation of a write current according to a magnetic field. Referring to FIG. 6, the X-axis indicates the strength of an external magnetic field, and the Y-axis indicates the amount of current required for writing. On the X-axis, “Hₑₓₜ” indicates the strength of an external magnetic field, and “H_{off}” indicates an offset of an R-H loop. “H_{co}” indicates a critical switching field at which a magnetization direction of a magneto-resistive element is switched when no current flows.

The R-H loop may be a curve graph indicating a relation between a resistance value R of a magneto-resistive element and a horizontal magnetic force H. On the Y-axis, “I” indicates a current, “I_{CO}” indicates a critical STT switching current, and “I_{db}” indicates a breakdown current.

A first line M indicates a write current WC2 required depending on an external magnetic field when the magnetization directions of the free layer is switched into an anti-parallel state AP from a parallel state P. The following equations 1 and 2 may be used to indicate a switching energy barrier (Δ) expressed by a magnetic field H and a current I.

$$Δ = {{Δ}_{0} ( 1 - \frac{H}{{H}_{CO}} )}^{2} ( 1 - \frac{1}{{I}_{CO}} ) \qquad ( 1 )$$

Referring to the equation 1, “H_{CO}”, “I_{CO}”, and “Δ₀” indicate a critical horizontal magnetic force, a critical current, and an original switching energy barrier, respectively. When the free layer of the magneto-resistive element is switched into the anti-parallel state AP from the parallel state P, an external magnetic field H applied in a direction of the anti-parallel state AP may lower the energy barrier (Δ). That is, a write current consumed when an external magnetic field is applied in a magnetization direction of a free layer to be written may be less than that consumed when no external magnetic field exists.

$$Δ = {{Δ}_{0} ( 1 + \frac{H}{{H}_{CO}} )}^{2} ( 1 - \frac{1}{{I}_{CO}} ) \qquad ( 2 )$$

However, referring to the equation 2, when switched into the anti-parallel state AP from the parallel state P, an external magnetic field H/H_{CO} applied in a direction of the parallel state P may increase the energy barrier (Δ). That is, a write current consumed when an external magnetic field is applied in a direction opposite to a magnetization direction of the free layer to be written may be more than that consumed when no external magnetic field exists.

Referring to the first line M, if an external magnetic field is applied in a parallel (P) direction at switching of magnetization directions of the free and pinned layers into the anti-parallel state AP from the parallel state P, a large amount of current may be required. If the external magnetic field is applied in an anti-parallel (AP) direction, the amount of current needed at writing may decrease. Further, as indicated by the first line M, a period in which a data value of ‘1’ is written at an MRAM cell may be a period between a breakdown current I_{bd} and a point at which a current is “0”.

A second line L may indicate a write current according to an external magnetic field when magnetization directions of the free and pinned layers are switched into the parallel state P from the anti-parallel state AP. Referring to the second line L, if an external magnetic field is applied in a parallel (P) direction during switching of magnetization directions of the free and pinned layers into the parallel state P from the anti-parallel state AP, the amount of current required may be decreased. However, if the external magnetic field is applied in an anti-parallel (AP) direction, the amount of current needed at writing may be increased. Further, as indicated by the second line L, a period in which a data value of ‘0’ is written in an MRAM cell may be a period between a breakdown current −I_{bd} and a point at which a current is “0”.

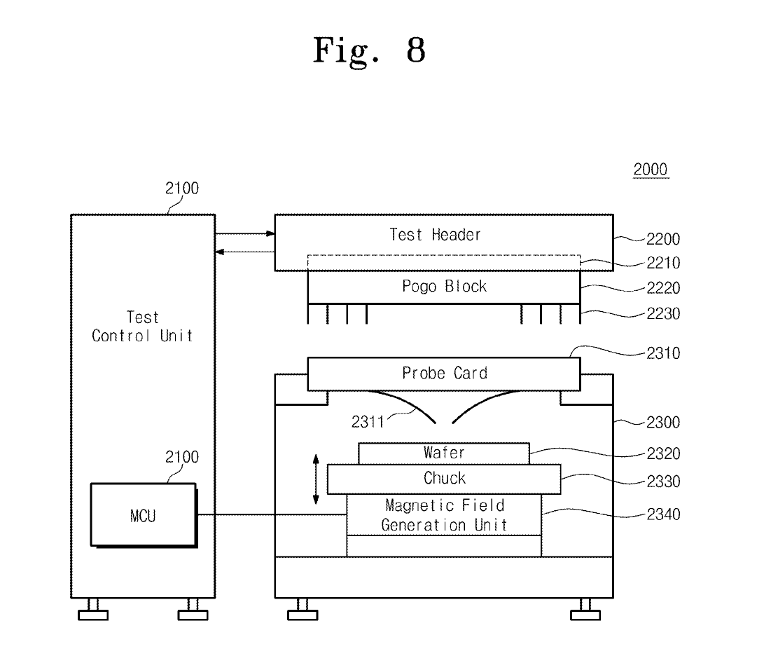

FIG. 7 is a block diagram schematically illustrating a magnetic control unit and a magnetic field generation unit according to an embodiment of the inventive concepts. Referring to FIG. 7, a magnetic field generation unit 1240 may comprise an electromagnet, as opposed to a permanent magnet. A permanent magnet always maintains magnetism regardless of a current supply. An electromagnet may be magnetized when a current flows, and may return to an original state when no current flows. By using an electromagnet, it is possible to artificially control the strength and direction of a magnetic field by controlling a current through the electromagnet.

The magnetic field generation unit 1240 may include a power unit 1241 and a solenoid 1242. The solenoid 1242 may be a cylindrical coil of wire, and a magnetic field may be set up by passing a current through the coil of wire. The strength of a magnetic field may be increased by inserting an iron core in the solenoid. The magnetic control unit 1300 may transfer a control signal to the power unit 1241 of the magnetic field generation unit 1240. The power unit 1241 may control the strength of current flowing through the coil in response to the input control signal.

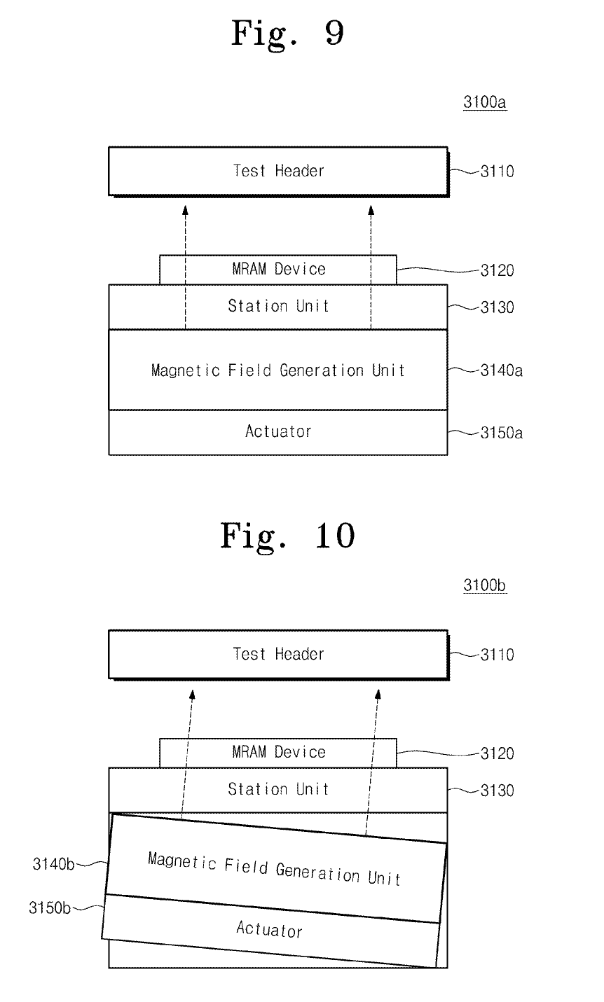

FIG. 8 is block diagram schematically illustrating a test apparatus according to another embodiment of the inventive concepts. An EDS process may be performed to test electrical properties of semiconductor devices which are formed on a wafer during a fabrication process. Referring to FIG. 8, a test apparatus to perform the EDS process may include a test control unit 2100, a test header 2200, and a probe room 2300.

The probe room 2300 may provide a space for testing electrical properties of a semiconductor device. A probe card 2310 having probe needles 2311 for electrical connection with a semiconductor device 2320 may be placed at a top of the probe room 2300. The probe card 2310 may provide a medium which enables electrical signals generated from the test control unit 2100 to be transferred to the semiconductor device 2320. The semiconductor device 2320 may, for instance, be formed on a wafer.

A chuck 2330 for supporting the semiconductor device 2320 and a magnetic field generation unit 2340 may be placed within the probe room 2300. The chuck 2330 may fix the semiconductor device 2320 on the chuck 2330, and may transfer the semiconductor device 2320 to a test position during a test operation. The magnetic field generation unit 2340 may be placed at a bottom of the chunk 2330. The magnetic field generation unit 2340 may apply a magnetic field when electrical properties of the semiconductor device 2320 are to be tested.

The test header 2200 may be electrically connected with the test control unit 2100, and may selectively dock with the probe card 2310 at testing. During testing, an electrical signal transferred from the test control unit 2100 may be provided to the probe card 2310 through the test header 2200.

The test header 2200 may include a test board 2210 suitable for testing a characteristic of a semiconductor device under test and a pogo block 2220 connected with a lower part of the test board 2210. The pogo block 2220 may include a plurality of pogo pins 2230 electrically connected with the probe card 2310.

An electrical signal generated from the test control unit 2100 may be transferred to the probe card 2310 through the test board 2210 of the test header 2200 and the pogo pins 2230 of the pogo block 2220. An electrical signal transferred to the probe card 2310 may be applied to the semiconductor device 2320 via an electrode terminal. The semiconductor device 2320 may perform an operation corresponding to the input electrical signal, and may output an electrical signal of a test result through the electrode terminal.

The test result electrical signal output from the electrode terminal may be provided to the probe card 2310 via the probe needle 2311 connected with the electrode terminal and sent to the test header 2200. The test control unit 2100 may determine whether the semiconductor device 2320 is defective, based on the electrical signal of the test result provided from the test header 2200. That is, the test control unit 2100 may output an electrical signal for testing of the semiconductor device 2320, and may determine whether the semiconductor device 2320 is defective, based on the electrical signal of the test result.

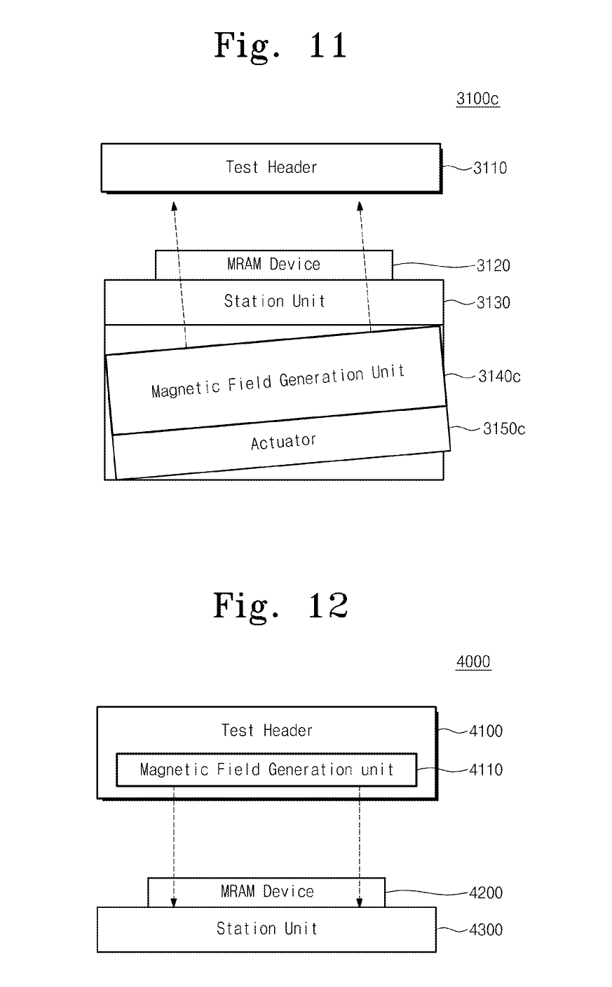

FIGS. 9 to 11 are block diagrams schematically illustrating a test apparatus according to still another embodiment of the inventive concept during various test operations of the test apparatus. In particular, a test apparatus may test whether an electrical operation is abnormal, based on a direction of an external magnetic field applied to a semiconductor device 3120 including a plurality of MRAM cells. Referring to FIG. 9, a test device 3100a may include a test header 3110, a station unit 3130, a magnetic field generation unit 3140a, and an actuator 3150a.

The magnetic field generation unit 3140a may be placed under the station unit 3130, and may apply a vertical magnetic field to the semiconductor device 3120 at testing. The actuator 3150a may be driven to adjust an angle of the magnetic field generation unit 3140a with respect to the station unit 3130. Driving of the actuator 3150a may be controlled by a magnetic control unit (not shown) which can further control the strength of a magnetic field generated by the magnetic field generation unit 3140a.

Referring to FIG. 10, a test device 3100b may be disposed such that a magnetic field generation unit 3140b is inclined downward in a right direction with respect to the station unit 1330 using the actuator 3150b. When the direction of the magnetic field generation unit 3140b is inclined downward in the right direction, a direction of influence of a magnetic field on the semiconductor device 3120 may be biased right with respect to a reference axis.

Referring to FIG. 11, using the actuator 3150c, a test device 3100c may be disposed such that a magnetic field generation unit 3140c is inclined downward in a left direction. When a horizontal direction of the magnetic field generation unit 3140c is inclined downward in the left direction with respect to the station unit 3130, a direction of influence of a magnetic field on the semiconductor device 3120 may be biased left with respect to a reference axis.

As illustrated in FIGS. 9 to 11, the test device 3100a/3100b/3100c may control a direction of application of an external magnetic field with respect to the semiconductor device 3120 including MRAM cells. Thus, it may be determined how the data reliability of the semiconductor device 3120 may be improved by applying an external magnetic field in various directions.

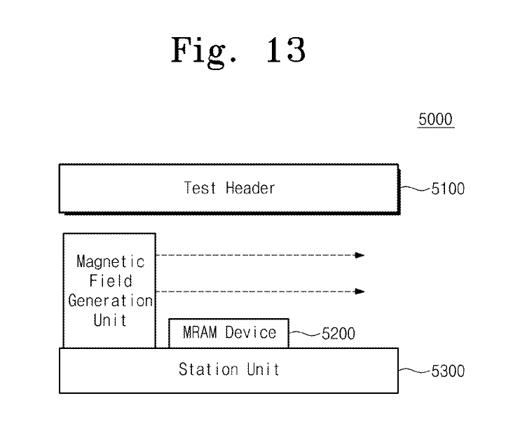

FIG. 12 is a block diagram schematically illustrating a test apparatus according to still another embodiment of the inventive concepts. Referring to FIG. 12, a test apparatus 4000 may include a test header 4100 and a station unit 4300. A magnetic field generation unit 4110 may be included in the test header 4100. The magnetic field generation unit 4110 may apply a vertical magnetic field to a semiconductor device 4200 including MRAM cells. The strength of an external magnetic field may be adjusted, for instance, by adjusting a distance between the semiconductor device 4200 and the test header 4100. The test apparatus 4000 may apply an external magnetic field to the semiconductor device 4200 including MRAM cells using the test header 4100 to test the data reliability under the influence of the magnetic field.

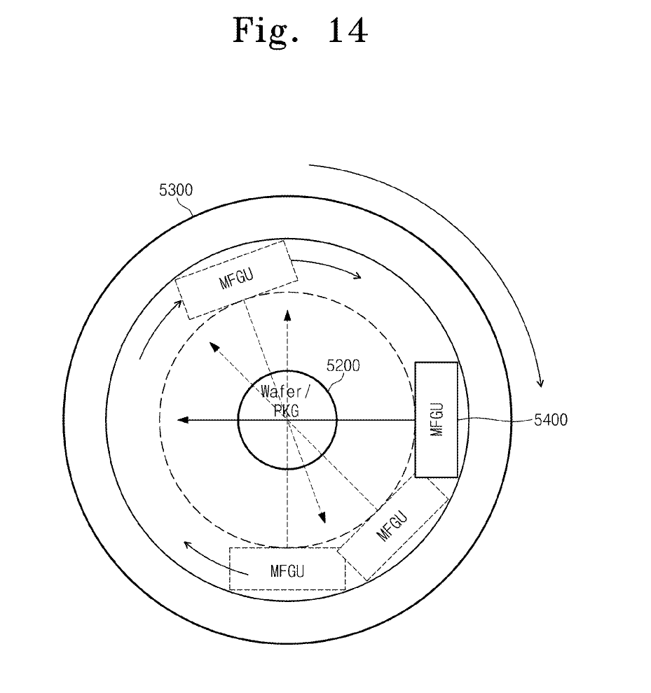

FIGS. 13 and 14 are diagrams schematically illustrating a test apparatus according still another embodiment of the inventive concepts. Referring to FIGS. 13 and 14, a test apparatus 5000 may include a test header 5100, a magnetic field generation unit 5400, and a station unit 5300. A semiconductor device 5200 may be placed at a center of the station unit 5300, and the magnetic field generation unit 5400 may be placed along or near an edge of the station unit 5300. The semiconductor device 5200 may be at a wafer or package level.

A shape of the station unit 5300 may be circular, and the station unit 5300 may rotate on the basis of a center axis. When the station unit 5300 rotates, the magnetic field generation unit 5400 placed near the edge of the station unit 5300 may rotate around the center axis while the semiconductor device may remain stationary. In this case, a horizontal magnetic field may be applied to the semiconductor device 5300 in every direction (i.e., 360 degrees). The magnetic field generation unit 5400 may comprise a permanent magnet.

In FIGS. 13 and 14, the test apparatus 5000 may test the data reliability of the semiconductor device 5200 when a horizontal magnetic field is applied to the semiconductor device 5200 including MRAM cells in various directions.

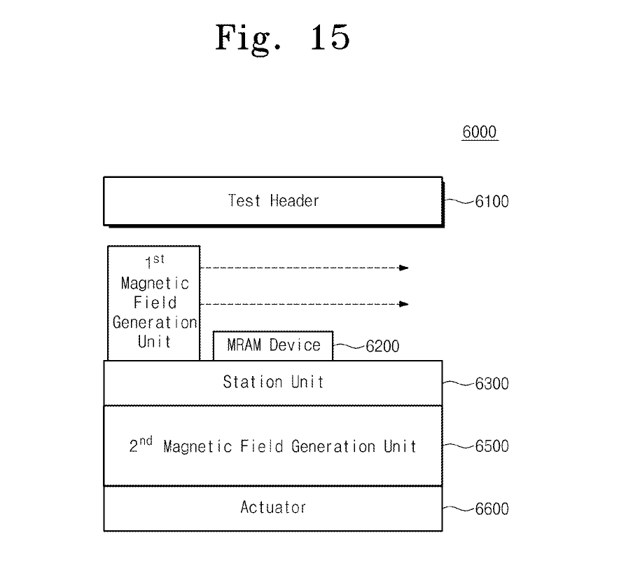

FIG. 15 is a block diagram schematically illustrating a test apparatus according to still another embodiment of the inventive concepts. Referring to FIG. 15, a test apparatus 6000 may include a test header 6100, a station unit 6300, a first magnetic field generation unit 6400, a second magnetic field generation unit 6500, and an actuator 6600.

The first magnetic field generation unit 6400 may be placed at an edge of the station unit 6300, and may apply a horizontal magnetic field to a semiconductor device 6200. The second magnetic field generation unit 6500 may be placed under the station unit 6300, and may apply a vertical magnetic field to the semiconductor device 6200 during testing. The actuator 6600 may be driven to adjust a horizontal angle of the second magnetic field generation unit 6500 in relation to the station unit 6300.

In FIG. 15, the test apparatus 6000 may test the data reliability of the semiconductor device 5200 when a horizontal magnetic field and a vertical magnetic field are simultaneously applied to the semiconductor device 6200 including MRAM cells in various directions.

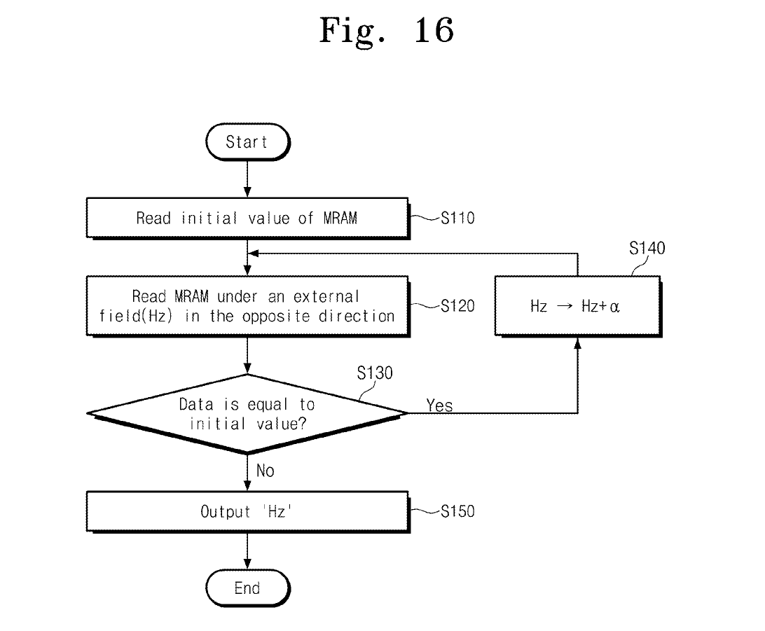

FIG. 16 is a flow chart schematically illustrating a read operation testing method according to an embodiment of the inventive concepts. More particularly, FIG. 16 illustrates a method for testing data retention of a semiconductor device in which a read current and an external magnetic field are applied to the semiconductor device at the same time.

Referring to FIG. 16, in operation S110, an initial data value may be read from a semiconductor device including magneto-resistive elements using a read current. Afterwards, in operation S120, data may be read from the semiconductor device while an external magnetic field is applied to the semiconductor device. A magnetic direction of the external magnetic field Hz may be opposite to that of a free layer of a magneto-resistive element included in the semiconductor device. In operation S130, it is determined whether the read data is equal to the initial data value.

If the read data is equal to the initial data value, the method proceeds to operation S140, in which the strength of the external magnetic field increases. Afterwards, the method proceeds to operation S120. If the read data is different from the initial data value, the method proceeds to operation S150, in which a value of the external magnetic field applied when the read data is determined to be different from the initial data value is measured. With the test method of FIG. 16, the data reliability and retention may be measured by continuously reading data as the strength of the external magnetic field increases.

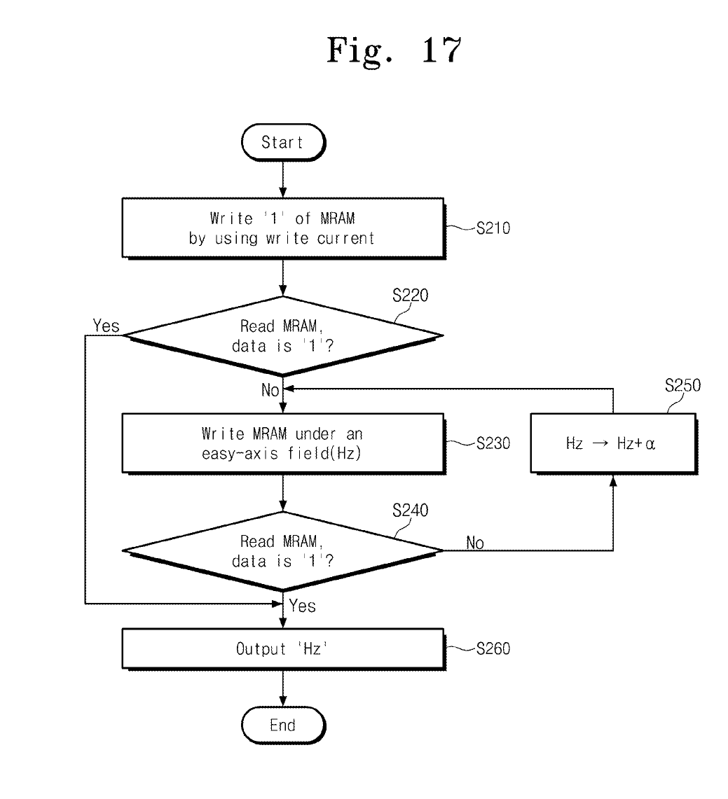

FIG. 17 is a flow chart schematically illustrating a write operation testing method according to an embodiment of the inventive concepts.

In a semiconductor device having magnetic memory elements, magnetization directions of free and pinned layers can be biased according to a characteristic of a magneto-resistive element. An energy required to magnetize the free and pinned layers in parallel may be more than that required to magnetize the free and pinned layers in anti-parallel directions, and vice versa. A write current and an external magnetic field may be applied at the same time to test characteristics of the magneto-resistive elements.

Referring to FIG. 17, in operation S210, a data value ‘1’ may be written to a semiconductor device including magneto-resistive elements using a write current. Herein, the write current may be equal in magnitude to a current level required to switch a general cell.

In operation S220, it is determined whether the data value ‘1’ has been written to the semiconductor device. If the data value ‘1’ was not written to the semiconductor device, this may mean that the magnetization directions of the free and pinned layers are biased. Thus, in operation S230, the write current and the external magnetic field may be applied at the same time. A magnetic direction of the external magnetic field may be the same as a magnetization direction of the free layer to be written.

In operation S240, it is again determined whether the data value ‘1’ has been written to the semiconductor device. If the data value ‘1’ was not written to the semiconductor device, the method proceeds to operation S250, in which the strength of the external magnetic field is increased. Afterwards, the method proceeds to operation S230. Returning to operations S220 and S240, when the data value ‘1’ is determined to have been written to the semiconductor device, in operation S260, the external magnetic field applied is measured at the point in time when the data is determined to have been written to the semiconductor device. In other example embodiments, it should also be understood that a similar test operation can be performed when the data value ‘0’ is written to the semiconductor device.

Using the test method of FIG. 17, it is possible to measure how write operation conditions are affected by a magnetization characteristic of a magneto-resistive element by sequentially increasing the strength of the external magnetic field during a data write operation.

As will be apparent from the above description, a test apparatus of the inventive concepts may evaluate influences of an external magnetic field on the operation of a semiconductor device by testing an electrical property of the semiconductor device while the external magnetic field is applied. Thus, it is possible to determine a degree of influence of an external magnetic field with quantitative data.

While the inventive concepts have been described with reference to various exemplary embodiments, it will be apparent to those skilled in the art that changes and modifications may be made without departing from the spirit and scope of the present invention. Therefore, it should be understood that the above embodiments are not limiting, but are merely illustrative.

What is claimed is:

1. A test apparatus comprising:
a test control unit configured to input an electrical signal for testing a semiconductor device including a magneto-resistive element and to receive an output test result signal from the semiconductor device;
a station unit configured to support the semiconductor device during testing;
a magnetic field generation unit configured to apply a magnetic field to the semiconductor device during testing of the semiconductor device; and
a magnetic control unit configured to control the magnetic field generation unit,
wherein an electric characteristic of the semiconductor device can be tested while a magnetic field is applied to the semiconductor device.

2. The test apparatus of claim 1, wherein the magnetic control unit controls a direction and strength of the magnetic field.

3. The test apparatus of claim 2, further comprising:
an actuator configured to adjust an angle of the magnetic field generation unit with respect to the station unit to change a direction of a magnetic field applied to the semiconductor device.

4. The test apparatus of claim 1, wherein the station unit is a wafer chuck and the semiconductor device is at a wafer level.

5. The test apparatus of claim 1, wherein the station unit is a socket and the semiconductor device is at a package level.

6. The test apparatus of claim 1, wherein the magnetic field generation unit is arranged under the station unit and configured to apply a vertical magnetic field to the semiconductor device.

7. The test apparatus of claim 1, wherein the magnetic field generation unit is arranged on one side of the station unit and configured to apply a horizontal magnetic field to the semiconductor device, and wherein the station unit is configured to rotate to change a direction of the magnetic field applied to the semiconductor device.

8. A read operation testing method of a semiconductor device comprising:
reading an initial data value from a semiconductor device including a magneto-resistive element using a read current;
reading data from the semiconductor device while an external magnetic field is applied to the semiconductor device; and
measuring a value of the external magnetic field applied at a point of time when the read data is different from the initial data value.

9. The read operation testing method of claim 8, wherein a magnetic direction of the applied external magnetic field is arranged opposite to a magnetization direction of a free layer of the magneto-resistive element in the semiconductor device.

10. A write operation testing method of a semiconductor device comprising:
attempting to write data to a semiconductor device including a magneto-resistive element using a write current;
determining whether the data was written to the semiconductor device;
if the data was not written to the semiconductor device, then repeatedly attempting to write the data by applying an incrementally increasing external magnetic field while over-applying a write current; and
measuring a value of the external magnetic field applied at a point in time when the data is successfully written.

11. The write operation testing method of claim 10, wherein a magnetic direction of the external magnetic field is the same as a desired magnetization direction of a free layer of the magneto-resistive element to be written.

12. A test apparatus for testing a semiconductor device including a magnetic memory element, the test apparatus comprising:
a test header for supplying signals to the semiconductor device being tested and for receiving signals from the semiconductor device being tested;
a station unit for supporting the semiconductor device being tested; and
a magnetic field generation unit for supplying a magnetic field to the semiconductor device being tested.

13. The test apparatus of claim 12, wherein the magnetic field generation unit is arranged along a side of the semiconductor device to be tested to supply a magnetic filed in a horizontal direction.

14. The test apparatus of claim 13, wherein the station unit is configured to rotate to change a direction of a magnetic field applied to the semiconductor device being tested.

15. The test apparatus of claim 12, wherein the magnetic field generation unit is arranged in the test header.

16. The test apparatus of claim 15, wherein the distance between the test header and the semiconductor device can be adjusted to control a strength of a magnetic field applied by the magnetic field generation unit to the semiconductor device being tested.

17. The test apparatus of claim 12, wherein the magnetic field generation unit is arranged beneath the station unit.

18. The test apparatus of claim 17, further comprising an actuator connected to the magnetic field generation unit and configured to adjust an angle of the magnetic field generation unit with respect to the semiconductor device being tested.

19. The test apparatus of claim 12, further comprising a magnetic control unit configured to control the strength, direction, or both strength and direction, of a magnetic field applied by the magnetic field generation unit to the semiconductor device being tested.

20. The test apparatus of claim 19, wherein the magnetic field generation unit comprises an electromagnet.
